(19) United States
(12) Patent Application Publication
(10) Pub. No.: US 2005/0268328 A1
(43) Pub. Date: Dec. 1, 2005

(54) Trust establishment for multi-party communications

(76) Inventor: Gabriele Corliano, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/518,897

(22) PCT Filed: Jun. 24, 2003
(86) PCT No.: PCT/GB03/02709

§ 371 Date: Dec. 22, 2004

(30) Foreign Application Priority Data
Jul. 3, 2002 (EP) 02254670.9

(51) Int. Cl. G06F 15/16

(52) U.S. Cl. 726/3

(57) ABSTRACT

The invention relates to establishing trust between parties prior to a multi-party communications session over the Internet or the like. This is achieved by the exchange of messages describing participant roles required to be performed during a session, and the assumption of the described roles by the parties to a session. The assumption of a role is non-repudiable via the use of digital signatures, in that a party must digitally sign the message or part thereof which indicates that it intends to assume a role. The roles relate to control functions to be performed during the session, such as Quality of Service determiner, or Quality of service signaller.

### TECHNICAL FIELD

The present invention relates to communications, and in particular to multi-party communications over the Internet. More particularly the present invention relates to the establishment of trust relationships between multiple parties relating to a communications session held or to be held between the parties.

### BACKGROUND TO THE INVENTION

The current design of multi-party multimedia sessions envisages the fact that different participants can own, within one session, different portions of control. Protocols implementing this control—mainly call and QoS (Quality of Service) signalling protocols—are designed in such a way so as to be flexible and applicable independently one from the other.

However, current multimedia sessions—and consequently the applications provided on their top—are created and managed by protocols which rely on the fact that the network, besides routing and forwarding, also implements admission control and policing, thus regulating the actions undertaken by whoever within the session. Admission control determines whether there are sufficient available resources to supply the requested QoS. Policing determines whether the user has administrative permission to proceed (e.g. make a certain QoS reservation). Both these functions involve blocking the flow whilst checking every packet against restrictions; by checking the flow, the network solves the problem of potential fraudulent transactions being undertaken by a user. In practice, during the phase of session set-up, when network resources for the session are allocated and participants assume some control over a session, the network regulates the access and behaviour of session participants by checking, and eventually blocking, participants' packets.

Nevertheless, when introducing an architecture which saves the network from having to implement admission control and policing, moving both functionalities to customers' end-systems, multimedia sessions will no longer be secure against fraudulent actions taken by participants. The network may only use very simple protection for itself, for instance by applying a tariff that charges extra when the customer continues to use the network during periods of congestion, as described in our earlier International Patent application No. PCT/GB 99/01773 In fact, it is the network, this time, which relies on customers' end-systems for implementing admission control and policing; in practice, the network is no longer able to apply policies to the flowing packets, which then travel undisturbed without being checked. Substantially, this situation means that whoever owns a portion of control within the session is uncontrolled by any mechanism within the network, potentially allowing him to defraud other participants.

This leads to a security problem: how can one be sure that a party is properly performing admission control and policing, rather than trying to defraud the other participants by exploiting its portion of control? And then, how can possibly mutually unknown participants trust each other when participating to a common session, assuming that everyone can potentially defraud someone else? For example, signalling the level of quality of service (QoS) is very important within a session, as it typically determines the price someone is going to pay for that particular use of the session. Assuming that who is signalling QoS is not who is actually paying for it, it is true that an action undertaken by the QoS signaller will impact the amount of money someone else is going to pay. There is therefore a problem in that given a future network which performs no admission control or policing of its own, and envisaging a scenario where control functions relating to a session can be split between multiple parties, how can a paying party trust an unknown party (e.g. the QoS signaller) who is free to defraud him (e.g. determine a QoS level for which the payer does not agree to pay).

### SUMMARY OF THE INVENTION

In order to address the above problem the present invention provides a method and system which makes use of call signalling protocols in the session set-up phase, and in particular extends the call signalling protocols to allow a web of control relationships to be built up. At present, sessions are created, managed, and released through specific call signalling protocols. These protocols are the vehicle of the session description, which is a collection of all the parameters needed to build the session up; participants need to mutually exchange the session description and negotiate its parameters in such a way to get common values to be applied to the session. Clearly, the format of the session description is in turn defined by a protocol or protocol description language. The present invention extends call signalling and session description protocols in such a way as to build up a web of trust relationships as the session is being built. It is in fact possible to exploit the session set-up phase—when the session description is being negotiated and the resulting session created—to make customers negotiate the control over the session and sign a non-repudiable proof of their liability against the control they assumed. The result is a common platform over which participants can operate being sure of the trustworthiness of the other parties. This is achieved through a signalling infrastructure that, by distributing control to parties and proofing the liability against that control, builds ad hoc trust relationships between different parties. The system builds trust by exploiting the classical security techniques (providing confidentiality, authentication, and non-repudiation) and the existing call signalling phases.

In view of the above, from a first aspect the present invention presents a method for initiating a communications session between two or more participants over a communications network, comprising the steps of:
exchanging messages containing non-repudiable data between said participants to establish at least one trust relationship therebetween relating to the session, said non-repudiable data indicating one or more session control functions to be assumed by individual participants during the session; and then
establishing the communications session.

By exchanging the messages containing the non-repudiable data relating to the control functions each party is willing to assume before the session is created, trust relationships between the parties may be created relating specifically to that session and no other. This then addresses the problem that one of the parties may attempt to defraud the other parties, by allowing each participant to assume a portion of control, and effectively declaring that he is then responsible for that control and no other, by virtue of the non-repudiability of the data.

In a preferred embodiment, the exchanging step comprises the following steps: defining one or more control functions to be performed by at least one of the participants during the session; communicating the defined control functions to the participants; at each participant: choosing which, if any, of the control functions the participant wishes to assume; generating a non-repudiable message indicating the chosen function(s); and
transmitting the generated message to at least one of the other participants.

Moreover, preferably the non-repudiable message comprises: data indicative of the chosen function(s); and at least one digital signature of the participant related to said data. By using a digital signature to “sign” the message, the other parties can ensure that the message did in fact generate from the transmitting participant, and is therefore genuine.

Preferably within the preferred embodiment the defining step comprises the step of communicating session charging policy data including data indicative of the control functions to a first one of the participants who has requested it from a service provider; and the communicating step further comprises communicating the session charging policy data from the first participant to the other participants. It is thus possible to initiate a session by a first participant requesting the service provider to send the session charging policy data to it, to allow the first participant to review it. If the first participant is happy with the network charging policy, he may then invite other participants to the session by sending them the charging policy. The charging policy will define the control functions which are required within the communications session which has been requested.

Preferably, within the preferred embodiment the first participant assumes those control functions defined within the network charging policy which no other participant has chosen to assume. By having this default setting it ensures that session set-up can proceed swiftly and with the minimum of delay imposed by the trust building phase of the present invention.

From a second aspect the present invention further provides a method for establishing at least one trust relationship between two or more participants and relating to a communications session between said participants over a communications network, comprising the steps of:
requesting session control function data from a network server, said data defining one or more control functions to be performed during the communications session;
choosing which, if any, of said control functions to assume;
distributing said control function data to at least one other participant over the telecommunications network; and
receiving a non-repudiable message from the at least one other participant containing non-repudiable data indicating which, if any, of the control functions the at least one other participants has assumed.

Preferably, the distributing step further comprises distributing to the at least one other participant non-repudiable data indicating which, if any, of the control functions have been assumed.

In the second aspect the invention provides steps which would typically be performed by a first participant who wishes to initiate a session within the preferred embodiment.

From a third aspect, the present invention also provides a method for establishing at least one trust relationship between two or more participants and relating to a communications session between said participants over a communications network, comprising the steps of:
supplying, upon request from a participant, session control function data, said data defining one or more control functions to be performed during the communications session;
receiving non-repudiable data from said participants indicating which, if any, of the control functions each participant has assumed; and
storing said data.

Preferably the third aspect provides the further step of checking the received non-repudiable data for any conflicts in the assumed control functions between two or more participants; and resolving any detected conflicts by assigning the disputed control function to only one of said participants who indicated that they would assume the function. This ensures that conflicts in control between participants can be resolved.

Moreover, within the third aspect there is also preferably provided the additional steps of checking the received non-repudiable data to determine the control functions which have been assumed; and assigning any control functions which have not bee assumed to a first participant, being the participant to which said network control function data was supplied. This allows all the required control functions to be assigned rapidly and without further negotiating messages having to be sent.

With the third aspect the present invention provides those steps which would typically be performed by a Service Provider such as an ISP during the operation of the invention within the preferred embodiment.

From a fourth aspect there is provided a method for establishing at least one trust relationship between two or more participants and relating to a communications session between said participants over a communications network, comprising the steps of:
receiving control function data from a first participant over the communications network, said control function data defining one or more control functions to be performed during the communications session;
choosing which, if any, of said control functions to assume;
generating a non-repudiable message containing non-repudiable data indicating which, if any, of the control functions have been assumed; and sending said message to the first participant.

With the fourth aspect, the present invention provides those steps which would typically be performed by another participant other than the session initiator within the preferred embodiment.

From a fifth aspect there is provided a computer program arranged such that when executed by a computer system it causes the computer system to operate according to any of the preceding aspects, and from a sixth aspect there is further provided a computer readable storage medium storing a computer program according to the fifth aspect. The computer readable storage medium may be any magnetic, optical, magneto-optical, solid-state, or other storage medium capable of being read by a computer.

Furthermore, from a seventh aspect the invention also provides a system for establishing at least one trust relationship between two or more participants and relating to a communications session between said participants over a communications network, said system comprising processing means arranged to operate according to the method of any of the previous aspects.

### BRIEF DESCRIPTION OF THE DRAWINGS

Further features and advantages of the present invention will become apparent from the following description of embodiments thereof, presented by way of example only, and by reference to the accompanying drawings, wherein:—

FIG. 1 illustrates a tree structure of liabilities which forms the basis of the present invention;

FIG. 2 is a block diagram illustrating how a contractual session can encompass a plurality of actual communication sessions;

FIG. 3 is a block diagram illustrating the participants in a typical trust establishment scenario according to the invention;

FIG. 4 is a block diagram illustrating the structure of a message used to establish a trust relationship in the embodiments of the present invention;

FIG. 5 is a diagram showing the structure of a session initiation protocol message (SIP) as used in the embodiments of the invention;

FIG. 6 is an equation which expresses PGP confidentiality;

FIG. 7 is an equation which expresses PGP authentication and non-repudiability;

FIG. 8 is a message flow diagram which illustrates the use of nonce values in the embodiments of the invention;

FIG. 9 is a diagram showing the PGP message format which may be used in embodiments of the invention;

FIG. 10 is a message sequence diagram illustrating statement construction and parsing in the embodiments of the invention;

FIG. 11 is a message sequence diagram illustrating the PGP encapsulation sequence used in the embodiments of the invention;

FIG. 12 is a state diagram showing the steps and the parties involved in extending SIP in accordance with the present invention;

FIG. 13 is a message sequence diagram illustrating the learning phase of the invention;

FIG. 14 is a message sequence diagram and block diagram illustrating the distribution phase of the invention;

FIG. 15 is a message sequence diagram and block diagram illustrating the liability distribution phase of the invention;

FIG. 16 is a Classical Session Establishment message sequence diagram;

FIG. 17 is a Liability Release message sequence diagram;

FIG. 18 is a state diagram showing the overall state machine of the embodiment;

FIG. 19 shows the individual states and the order in which they are assumed of the main parties to the embodiment;

FIG. 20 shows the states assumed by the session initiator,

FIG. 21 shows the states assumed by a called participant;

FIG. 22 shows the states assumed by the local ISP;

FIG. 23 shows the states assumed by the remote ISP;

FIG. 24 illustrates an operating environment for embodiments of the invention; and

FIG. 25 illustrates the message flows in a second embodiment of the invention.

### DESCRIPTION OF THE EMBODIMENT

An embodiment of the invention will now be described, with reference to the drawings. The description of our embodiment is split into three parts. First, the rationale and background of the design of our signalling infrastructure will be explained. Then, the overall structural architecture of the embodiment will be described, followed finally in the third part by a description of the precise method steps taken by each party in the invention.

Signalling Infrastructure for binding control and Liability

The embodiment of the invention re-uses existing protocols for session management (call signalling and session description protocols) as the underlying mechanisms for establishing trust relationships between session participants. The way in which a trust relationship is established is by making a party generate and distribute an (cryptographically secure) electronic liability for each portion of session control.

Participants within multimedia sessions behave in a way that can be classified according to a number of parameters. To aid in understanding the invention, we will try to illustrate this classification, and to formalise the terminology.

First of all, herein we defined that a party using a service through an application can be interchangeably called a user, with respect to an application, or a participant, with respect to a session, or customer, with respect to a service.

Within a multimedia session, a party may either initiate the session, or join it by invitation. Herein a party behaving in the first way is called the session initiator; a party who behaves in the second manner is called a session participant. We will then call a third party whoever is neither session initiator, nor participant. In the following, we will refer to these three behaviours as user roles.

Moreover, thanks to the ductility of packet networks, it has been possible to distribute the control over a session among different parties, creating a new way to distinguish them, that is to say, a new way to classify them. Each party involved in the session can accept to have a portion of control, where for portion of control is intended control over a certain set of actions within the session. Each portion of control that a party can have defines a task role, i.e. a task role defines and describes the portion of control that a party may have within a session. In the table below, task roles are listed, beside their description.

Task roles are mutually bounded by a hierarchical relationship given by a temporal order. For example, a party can use the application only after the QoS signaller has completed his task. Later it will be seen how it is possible to bind all these roles by another relationship, i.e. the liability for a portion of control.

Note how each one of the task roles described above defines a set of actions that may generate a variation of the charges for service usage. This is a key point in the solution provided by the invention, since the actual problem effectively arises because of the liability implied by these actions, i.e. those ones that may let the charges vary.

TABLE 1
Task Roles

| Task Role | Description |
|---|---|
| ISP customer | Party held liable for payment by the ISP |
| QoS payer | Party actually paying for QoS |
| QoS Determiner | Party determining QoS of the session |
| QoS Signaller | Party signalling the required QoS to the |
| | network |
| Usage Decider | Party deciding a specific usage of the |
| | application |
| Usage Actor | Party actually using the application of the |
| | session |
| Usage Measurer | Party measuring a specific usage of the |
| | application |

Within a multimedia session, two types of operation can be performed with respect to data transmission operations: either sending, or receiving data. Each of them, in turn, defines a role: the data sender, and the data receiver.

With respect to QoS signalling operations, two types of operation can be performed: either sending, or receiving signal messages. Each one of them defines a role: the signalling sender is the party who triggers the signal that causes the reservation. The signalling receiver is the party who receives a request for a resource reservation for the data flow.

It is important to make such a distinction, as in the solution of the problem the difference between signalling senders and data senders can be critical. Certain QoS signalling protocols, such as RSVP, involve the data-receiver initiating signalling to set up the QoS reservation of subsequent data reception; in this case, the data-receiver corresponds to the signalling-sender. If instead ToS flags in each data packet determine the level of QoS, the data-receiver would coincide with the signalling-receiver, because this is per-packet signalling. Furthermore, if some third party set up the level of QoS, then this third party would be the signalling party, either sender or receiver, according to the protocol.

We previously pointed out how, thanks to packet networks' ductility, it was possible to split session control in portions and distribute each portion to a different party. Through specific arrangements, a party would also be able to delegate her control to a third party acting on her behalf. The trust issues arising from such capabilities are of great concern.

In fact, a serious constraint to the application of these ideas lies in the fact that, to make them feasible, each portion of control must always be tied to a portion of liability for such control, forcing the party who accepts some control to accept, at the same time, the corresponding liability.

We consider a portion of control to be defined, and described, by a task role. Task roles are obviously provided, within a charging policy, by the ISP local to the session initiator. Before the multimedia session takes place, all the available task roles have to be assigned to a number of parties, and with them, the corresponding liabilities, thus binding each one of them to a task role. In this way, we are establishing a relationship between the name of a party, the actions she will perform, and a statement that she is liable for such actions. Substantially, portions of control and portions of liability can be considered different aspects of the same thing, the task role.

As task roles, seen as portions of control, can be mutually bounded by a hierarchical time relationship, at the same way, seen as portions of liability, they can be bounded by a new relationship, the destination of a liability. Indeed, a liability is basically described by two parameters: the liable party, and the party towards whom she is liable.

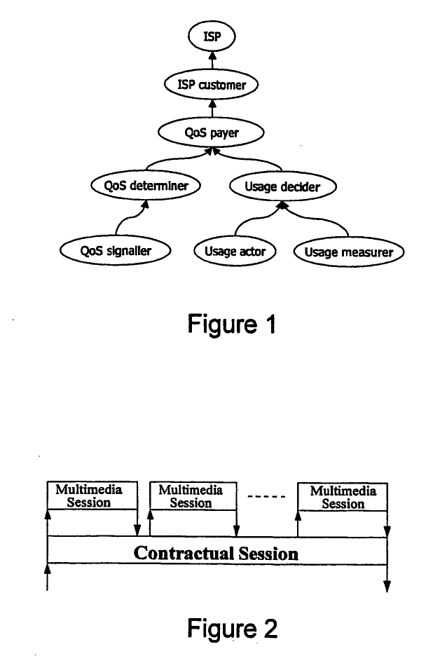

Binding together all the task roles as described, the resulting configuration is a tree, as shown in FIG. 1. At the nodes of this liability tree, there are the task roles, as set out above in Table 1. The relationship between task roles is given by an arrow that represents a due liability: the arrow begins from the party who dues a liability, and terminates to the party towards whom the liability is due.

Liabilities also have the characteristic of being time-dependent, with defined start and end times. The rules defining the duration of a liability (e.g. timers or updates) have to be defined at the beginning of the session; it would be otherwise difficult to maintain a coherency among all the actions different parties. We will distinguish then short-term and long-term liabilities. We can consider short-term liabilities to have the duration of a multimedia session: they are established with the multimedia session set-up, and released as the session is. On the other hand, long-term liabilities identify coarser granularity, as they are no longer established and released on per-multimedia-session basis, but rather per-super-session basis. We can imagine this super-session as the period of time when end customer and edge provider are tied by a contractual relationship (e.g. the duration of the overall charging policy). It is then reasonable to refer to this super-session as a contractual session. And we can further assume that a long-term liability is established the first time a customer uses a service, and it is released either when the provider wants to update it, or when a certain timeout, set by the provider, expires. However, a long-term liability is something that is negotiated between the customer and his local ISP (i.e. the contractual session is opened between each customer and the corresponding local ISP).

Short and long term liabilities identify a further distinction regarding the operations of setting up a multimedia session. Indeed, apart from the actual multimedia session set-up, it is possible to recognise two further signalling phases. During the first phase, long-term liabilities are established between the session initiator and the local ISP: the purpose is to open a contractual session. During the second signalling phase, the session initiator chooses a charging policy and negotiates short-term liabilities with the other participants. The positive completion of this second phase lets the actual multimedia session be established. This distinction between short term liabilities relating to a particular session, and long-term contractual liabilities is illustrated in FIG. 2.

The typical scenario in which our trust infrastructure is intended to work is that of a multimedia session. Within it, we basically recognise four entities: the session initiator, the participants, the service providers, and eventual third parties, being neither the initiator, nor a participant.

Whereas we consider the session initiator to be unique within the session, participants may be an indefinite number. So as to establish a coherent terminology, we will refer to participants to multicast sessions as joiners, and participants to unicast sessions as called. This distinction is made so as to introduce no ambiguity in the following description. However, in reality within multicast sessions it is likely that a participant would join the session, adding himself to the multicast group, whereas in unicast sessions, each participant is individually contacted.

Both the session initiator and the participants will refer to an Internet Service Provider (I SP) for service provision: the session initiator will refer to its local ISP, and each participant will refer to its local ISP. For terminology, we will refer to ISP's names from the session initiator point of view; we will term the “local ISP” that one where the initiator is attached, and a “remote ISP” each ISP which supplies Internet connectivity to one or more of the participants.

Note that not all the ISPs along the path between session initiator and any participant need to be involved or aware of the process.

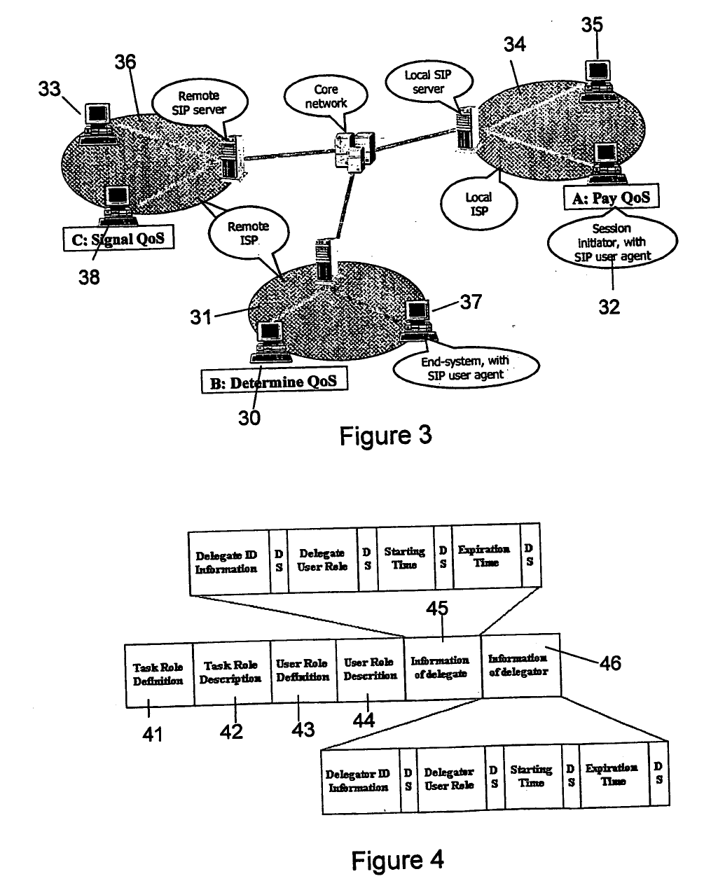

FIG. 3 illustrates example parties in a typical scenario. Here, a session intiator 32 has also agreed to be responsible for the payment of any QoS charges levied by the transport network for the session. The initiator 32 is connected to the core network via a local ISP 34. A further session participant 35 who has assumed no control functions is also connected to the local ISP. The local ISP is provided with a local session initiation protocol (SIP) server connected to the core transport network. SIP is an Internet Engineering Task Force draft standard, which at the priority date is described in RFC 2543 bis 9.

With regards to the remote parties to the session, four remote parties 30, 37, 33, and 38 are provided. The remote parties 30 and 37 are connected to a first remote ISP 31, whereas remote parties 33 and 38 are connected to a second remote ISP 36. Each of the remote ISP's are also provided with SIP servers connected to the core network. Within the first ISP area, the remote party 30 has signalled using the invention that it is willing to assume the control function of Determining QoS. Similarly, within the second remote ISP area, the remote party 38 has signalled using the invention that is it prepared to assume the control function of signalling QoS. The method provided by the present invention of signalling intentions to assume control functions is described later.

We will turn now to a discussion of charging policies and electronic liabilities. Broadly speaking, a policy is a set of rules to administer, manage, and control access to network resources. Charging policies contain rules specifically oriented to the management of service restrictions due to charging and payment issues (it can be simply a tariff). Our charging policy, besides ISP's rules and restrictions, will define which are the available portions of session control a party can accept (described as task roles) and, for each task role, which are the user roles allowed to accept it.

We suggest herein that a way for establishing trust between session participants with regards to session control is to make participants produce a cryptographically secure proof binding the portion of control they are assuming with the corresponding liability; and then to distribute this proof to all the involved parties.

Next we identify and define the content and format of an electronic liability, along with the operations required to manipulate it.

Substantially, an electronic liability corresponds to a section of the charging policy. We suggest to define such section as a matrix with a certain number of columns, and as many rows as the number of task roles. Each row corresponds to a task role. An example is shown in FIG. 4.

Here, within the first column 41, the service provider will list all the available task roles, and in the second one 42, it will describe them. The third column 43 determines the mapping between task roles and user roles: for each task role, the service provider will have to state which user roles are allowed to accept that task role; in the following column 44, these user roles are described. In the remaining two columns 45 and 46, the parties accepting a task role will have to insert their identification information.

As we already introduced, the signalling infrastructure allows a party to delegate her control. We need then to make a distinction between delegator and delegated parties: delegators ask delegated to accept some control on their behalf. If this happens, both parties will have to insert their identification information, but, whereas the liability will be established for the delegator, the task role will be assigned to the delegated.

Note how the delegator's user role will have to match one of the user roles defined by the service provider, whereas the delegated party does not need to fulfil this requirement.

The purpose of the first four columns 41 to 44 is to provide a mapping between each task role and the user roles the ISP believes to be the most indicated. The purpose of the last two columns 45 and 46 is instead to provide the mapping between a task role and an appropriate party. It is then the digital signature on the identification information that acts as the proof (providing non-repudiation) of an accepted liability for some control.

We will refer to single rows of the matrix as single statements and we will call it incomplete when the columns regarding the identification information are empty (i.e. no party has assumed that task role), and complete when there is the identification information of the party assuming the task role), along with the digital signature on this information.

Summarising, each one of the statements identifies an electronic liability. All the statements identify a set of mutual trust relationships among all the parties involved in the session. By opportunely distributing these statements among the involved parties, it is possible to create a web of trust relationships.

Having discussed the organisation of liabilities, we turn now to a discussion of the message format used to signal them. As we pointed out in previous sections, we use a call signalling protocol to distribute electronic liabilities to all the involved parties and thus establishing trust relationships.

The IETF has a draft standard known as the Session Initiation Protocol (SIP), presently described in RFC 2543. SIP messages have been designed for negotiating session features between participants and the natural content of a generic SIP message payload is then the session description.

In our embodiment of the present invention, we use an extension of SIP for conveying charging policies, and so electronic liabilities, along with the session description, within the SIP message payload. This implies that each time a SIP server or user agent have to produce a message forming part of this infrastructure, it will have to first retrieve or generate one or more charging policies. Then, include such charging policies, along with the session description, in the SIP message payload.

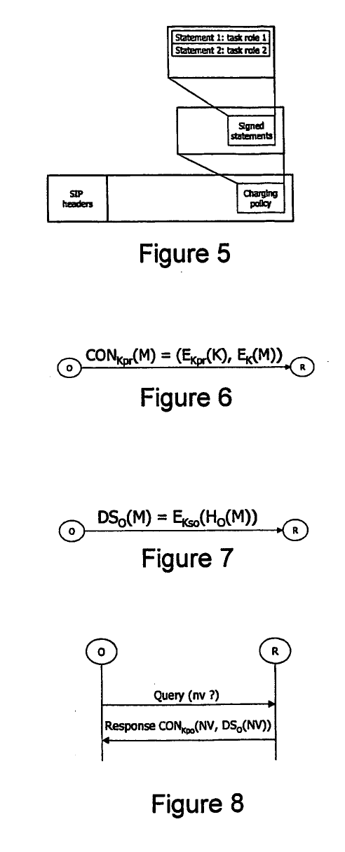

Note how the message exchange necessary for distributing electronic liabilities does not concern session features negotiation; this means that the session description itself can be empty, while the session description language can be re-used for describing charging policies. An example SIP message format incorporating the charging policies is shown in FIG. 5.

With reference to FIG. 5, we suggest a simple format for describing electronic liabilities. A single statement can be logically divided in two parts: the first one regarding charging policy's information (first four fields), the second one participant's information (latter two fields). Our simple format provides for colon-separated fields; besides, the sub-fields contained in the last four fields (globally four fields for the delegator, and four for the delegated) are semicolon-separated.

We will turn now to a discussion of the required security mechanisms needed to ensure non-repudiability of messages and data in the present invention. The actual individual security mechanisms themselves are well known in the art, and make use of asymmetric key techniques as developed by Rivest et al., and which are well known in the art.

In the proposed architecture, three security services are used to make secure the exchange of messages between different parties. Each one of these services is implemented by one or more security mechanisms, such as symmetric and public cryptography, digital signatures, and one-way hash functions. In this section we will provide an overview of how PGP (Pretty Good Privacy) security mechanisms achieve the required SIP security services.

Encryption

PGP is a hybrid cryptosystem, combining symmetric and public key cryptography. When a user encrypts plaintext, PGP first compresses the plaintext. Data compression not only saves modern transmission time and disk space, but strengthens cryptographic security enhancing resistance to cryptanalysis. PGP then creates a session key, which is a one-time secret key. This session key works with a fast symmetric encryption algorithm to encrypt the plaintext; the result is ciphertext.

Once the data is encrypted, the session key is then encrypted to the recipients public key. This public key-encrypted session key is transmitted along with the ciphertext to the recipient.

Decryption works in the reverse. The recipients copy of PGP uses his or her private key to recover the temporary session key, which PGP then uses to decrypt the symmetrically encrypted ciphertext.

The combination of the two encryption methods combines the convenience of public key encryption with the speed of symmetric encryption, being about 1,000 times faster than first one. Public key encryption in turn provides a solution to key distribution and data transmission issues. The public key encryption process is shown graphically in FIG. 6.

Digital Signatures:

Digital signatures enable the recipient of information to verify the authenticity of the information's origin, and also verify that the information is intact, thus providing authentication and data integrity. Moreover, they provide non-repudiation, preventing the sender from claiming that he or she did not actually send the information. A digital signature serves the same purpose as a handwritten signature, but it is more powerful: it is nearly impossible to counterfeit, plus it attests to the contents of the information as well as to the identity of the signer. The basic manner in which digital signatures are created consists in encrypting information using the sender private key. If the information can be decrypted with the sender public key, then he must have originated it.

Hash Functions:

The system described above is slow, and it produces an enormous volume of data. An improvement on the above scheme is the addition of a one-way hash function in the process. A one-way hash function takes variable-length input and produces a fixed-length output. The hash function ensures that, if the information is changed in any way, an entirely different output value is produced. PGP uses a cryptographically strong hash function on the plaintext the user is signing. This generates the message digest, which PGP uses, together with the private key, to create the signature. PGP transmits the signature and the plaintext together. Upon receipt of the message, the recipient uses PGP to recompute the digest, thus verifying the signature. As long as a secure hash function is used, there is no way to alter a signed message in any way. PGP Authentication and Non-repudiation is illustrated graphically in FIG. 7.

Nonce Values:

In addition to the above described function, we also need to add an auxiliary functionality to enforce security, by sending a nonce value in each message that applies non-repudiation. Indeed, a major aspect of this architecture lies in the fact that the exchange of all messages is valid just for one session, that is, whichever party cannot assume a portion of control for one session, and use the liability for another one (e.g. a customer who uses payment agreements for a session different from that one of which it has a portion of control). Furthermore, using a nonce value characterise the multimedia session in a unique way, protecting the customers by replay attacks. The recipient of a signed statement is the originator of the nonce value. When it receives the message, it checks if the nonce value it previously generated is present or not. If it is attached to the message, it means that the statement it received refers to the current session. FIG. 8 illustrates the use of a Nonce value as described above.

PGP Message Format

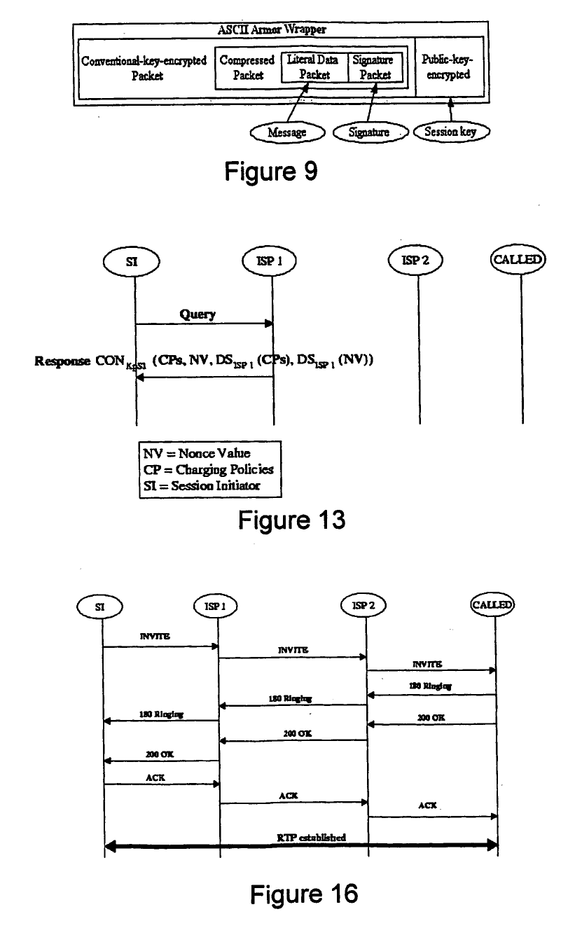

PGP provides its own format for encapsulating cryptographically secure messages. We call PGP file the product of all PGP encapsulation. Each PGP file is, in turn, composed by three components: message, signature, and session key component (the last two are optional). Each one of these components is represented by exactly one PGP packet. PGP defines a number of packets according to the use to which it is destinated. Some packets can be encapsulated one inside another, as in the case of compressed data. Basically, the idea behind PGP packets is to create one digital envelope for each kind of mechanism implemented by PGP. FIG. 9 illustrates an example PGP message format.

Constructing and parsing cryptographically secure SIP messages:

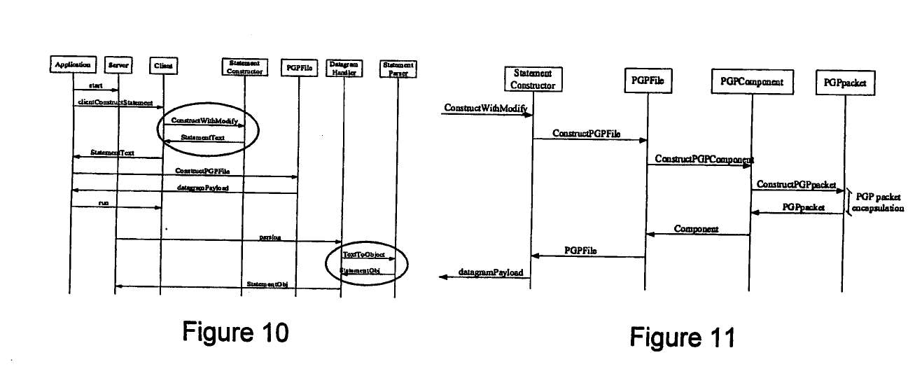

The software covering security features within our embodiment is organised in two components, a client, issuing requests, and a server, providing responses. FIG. 10 illustrates the sequence of Statement Construction & Parsing, whereas FIG. 11 illustrates a PGP encapsulation sequence diagram.

As shown in FIG. 10, the client basically has a statement object to send to the server. In this sense, it calls the statement constructor, it encrypts the message, and it sends it through an UDP socket. The server, already started at the beginning of the test application, is in idle, waiting to receive a message. As soon as it receives one, it spawns a thread for handling the message. This one is decrypted, parsed, and a statement object is created with the retrieved information.

The statement constructor operates as shown in FIG. 11. That is, it sends a command to a PGP module which consists of a PGP file, component, and packet generators. These generators construct a PGP encrypted datagram as shown, and is as generally known in the art already.

These classes have been written with purpose to re-use them within SIP. The idea of the present invention is to add the statement constructor inside the SIP message constructor (as the PGP file constructor has been reused inside the statement constructor). In the same manner, the statement parser, called at the server side, should be inserted where the SIP message is parsed. The extensions we have made to SIP are explained next.

SIP Extension:

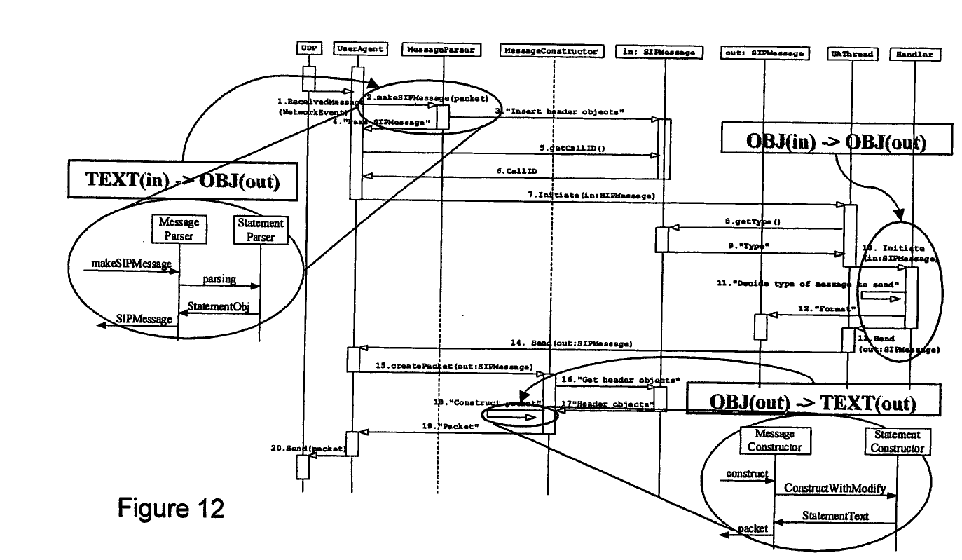

FIG. 12 illustrates the main three extensions made to SIP, in the context of the present operation of SIP within the preferred embodiment: new message parser, new behaviours, and new statement constructor.

We extend the SIP message constructor and parser by re-using some of the above-mentioned classes. In particular, we need to modify the SIP sequence diagram in such a way to add security features while constructing and parsing a SIP message, and include electronic liabilities in SIP messages.

Therefore, at the second and eighteenth step of the diagram we introduce new classes, in such a way as to construct the portion of message containing liabilities and security features.

Note how, in this version of the classes, PGP messages are constructed by using classical 8-bit bytes, and by exchanging arrays of bytes. Actually, PGP format (according to RFC 1991) provides for ASCII Armored messages, rather than arrays of bytes. The ASCII Armor format substantially is a wrapper for generic bytes, adopted to made printable messages transmitted over not binary channels.

Structural Architecture

Having described the background ideas to the present invention and the preferred embodiment thereof, we will now proceed on to the second part of our description, being that of a description of the structural architecture of the embodiment.

The trust infrastructure envisaged by the preferred embodiment of the present invention basically involves signalling operations. Based on SIP, it aims to set up and tear down portions of control and liability, described as task roles, securing the payment process.

An operation consists in an exchange of signalling messages through which one or a number of task roles (i.e. portions of control), and the corresponding liabilities, can be either established, or released. An operation of liability establishment happens when a party, willing to assume some control over the session, firstly generates a non-repudiable statement proving its liability against the control it assumed; then, she distributes the statement to all the other participants, making them aware of the assumed liability; this is the primary subject of the present invention. Liability release consists of invalidating the proof that a party is liable for control. However, it is clear how this operation must be agreed by an appropriate party (otherwise everyone would be able to set-up and tear down liabilities as he prefers).

A process is a set of operations; the infrastructure basically provides for two relevant processes: delegation of control and update of a liability. Control delegation substantially consists in establishing a liability for a party (the delegator), who is in turn delegating the corresponding control to another one (the delegated), who will not be directly liable for it. Liability update consists in changing the party who is owner of the liability; the considered liability is released for a party, and established for the other one. Hence, structurally, the signalling infrastructure consists of three modules:
Liability establishment accomplishes the target of establishing a liability, and it consists in turn of three phases. During the first learning phase, all the involved parties become aware of the charging policy and of the nonce value for the session. Through the second liability distribution phase the non-repudiable statements, along with the charging policy, are distributed and negotiated; the third phase then corresponds to the classical session set-up phase, which the existing SIP implementations provide.
Liability release
Control delegation

As mentioned above, the present invention is concerned with the first of the above modules, being that of liability establishment.

Liability Establishment

As already introduced, the establishment of a liability happens when a party, willing to accept some liability, generates some non-repudiable proof that she is really accepting that liability, and all the involved parties are aware of that, by receiving this proof. Next, we will describe an extension of SIP supporting the establishment of short and long term liabilities.

We propose to extend SIP in such a way as to establish short and long-term liabilities during the ordinary session set-up phase. Liability establishment is achieved in three phases:
i) During the learning phase, the local ISP becomes aware of the beginning of a multimedia session, and the session initiator becomes aware of the charging policy proposed by the ISP. According to what is defined in the policy, the initiator may decide to assume some control over the session
ii) During the distribution phase, the session initiator invites the other participants, including in the invitation the charging policy, the roles he decided to assume, and the proof of the correspondent accepted liabilities. The invitees reply to the invitation with the policy and the roles they decided to assume.
iii) The third phase consists of the classical call set-up phase. At the end of it, the session will be finally established.

During the learning phase, the session initiator contacts its local ISP, expressing the wish to open a session. Consequently, the ISP has to reply with a set of charging policies and a nonce value: the charging policies represent different ways for the initiator to create its session (different tariffs, with possibly different rules and restrictions); the nonce value is a security mechanism used by all the involved parties to uniquely identify the multimedia session.

Note how the first time a customer uses a service, the learning phase should also achieve the establishment of the contractual session, by setting up long-term liabilities.

This phase then consists of a two-way handshake, as shown in FIG. 13. First the initiator sends a query message to its ISP asking for a set of charging policies and for the nonce value of the session; and then, the ISP replies with the required information.

The handshake can be realised by either extending SIP, or designing a simple client-server application; this second approach is the preferred one. We define two simple messages: a query message asking for a set of charging policies and for the nonce value of the session to be opened, and a response message, returning the nonce value, and the corresponding digital signature of the ISP; and the set of charging policies (and the corresponding digital signature of the ISP).

In addition, the application should also provide a mechanism for binding queries and responses (e.g. a sequence number).

Once the session initiator has received the ISP's response, the session initiator will evaluate the various charging policies and choose one of them. If, eventually, he decides to assume some of the available portions of control, he will have to generate the corresponding proof for that liability; the time at generation will be the starting time of the liability. As described previously, the proof is the generation of the party's digital signature placed in the appropriate field of the matrix message structure, next to the role description which is to be assumed.

Distribution Phase

The target of this handshake is to let all parties be aware of the mapping between task roles and user roles and to let them negotiate the mapping between task roles and an appropriate party.

Once the session initiator has chosen a charging policy, he can start to contact the other participants and make them aware of the existing charging policy. To do so, he sends an INVITE request to all parties he wants to invite (or to the multicast group). The INVITE request message will include a charging policy, describing various portions of control, and as many statements as the number of roles the initiator decided to assume (or to delegate). In addition the INVITE request should also include a tag which makes the receiving terminal ring and the digital signature of the session intiator over the nonce value of the session

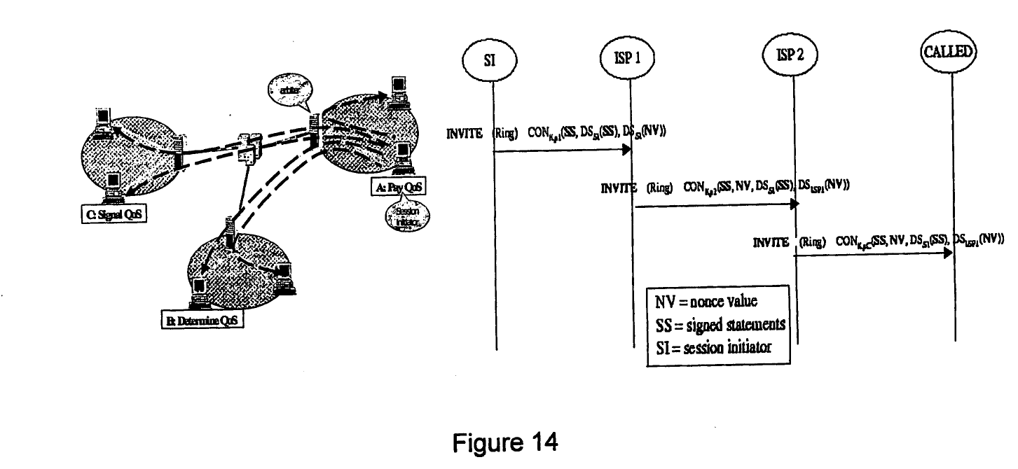

Such an INVITE request is sent hop-by-hop, as shown in FIG. 14. The first hop will be to the local ISP's SIP server, which has to store the signed statements contained in it and forward—again hop-by-hop, we need to force the message to traverse the remote ISP—the INVITE request to the destination. The remote ISP also has to store the signed statements and then forward the request to the participant.

Upon receipt of the INVITE request, each participant stores the signed statements. In addition, depending on the control he wants to accept, the participant generates his signed statements. Then, he encapsulates them (if any) in the response, and sends it back—hop-by-hop—to the session initiator. A 183 response message will then include:
i) The participant signed statements, if any (along with their digital signature); and
ii) The digital signature of the nonce value

It is during this phase that participants should have the opportunity to negotiate different portions of control over the session (provided that one role cannot be assigned to more than one participants). This negotiation can be designed in different ways, depending on the complexity we agree to add and on the existing features of the used call signalling protocol. We suggest a simple way of doing it by making participants do a one-time selection of the role to assume and exploiting the local ISP as the arbiter.

In fact, the local ISP will see all the responses traveling towards the session initiator. Before the ISP forwards them, it has to process their content. Its task will be to check that all the portions of control have been chosen, and that, if there are conflicts (more than one party over a portion), they are solved. As default the local ISP assigns those non-accepted control functions to the session initiator, asking for as many signed statement as there are portions of control. The local ISP will further solve conflicts of overlapping accepted control (e.g. by leaving such control to only of these parties and removing it from the others). Once it completes this check, the local ISP forwards the modified responses to the session initiator. In the presently described example, assume that all the portions of control have been accepted, and that there are no conflicts (i.e. the session initiator will receive all required statement and will not be forced to accept further control).

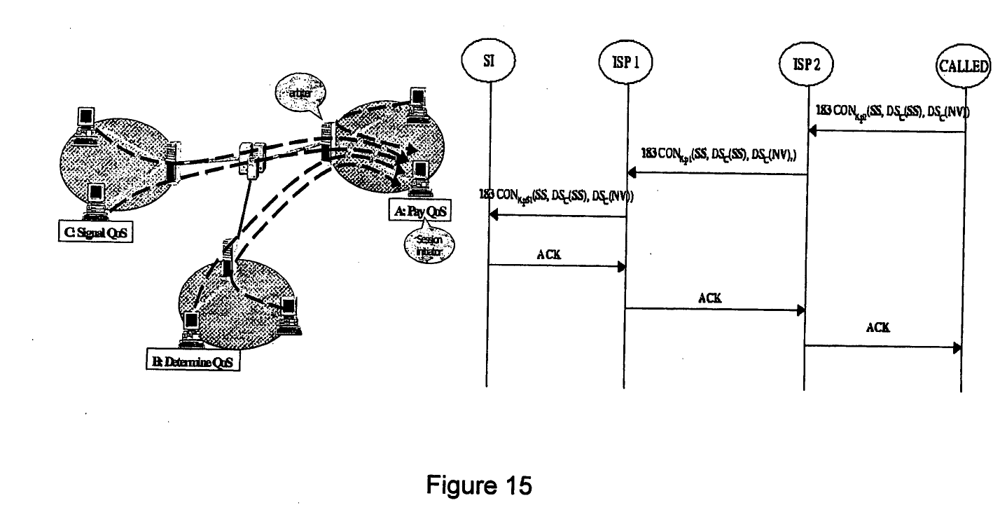

Upon receipt of all the responses, the session initiator stores all the signed statements and then replies to everyone with an ACK request, including the complete mapping between portions of control and accepting parties, and all the corresponding signed statements (i.e. one signed statement for every portion of control). This step is shown in FIG. 15.

If the local ISP arbitrarily assigned some portion of control to the session initiator (when solving conflicts), before forwarding the ACK request, it will have to check that the session initiator has included the appropriate signed statements. All the receiving parties, upon receipt of the ACK request will store the signed statements and stand-by for the real session set-up phase.

Starting and Expiration Time:

Joint to the identification information of the accepting party, the delegator and the delegated, there are further starting times and expiration times of a liability contained within the liability distribution message (see FIG. 4). Each one of these fields can be used in different ways according to the type of liability, whether long-term or short-term. At the moment, the infrastructure does not provide for any kind of use in case of long-term liabilities. Indeed, each time a customer stops using a service, the local ISP's user agent activates a timer. When the timer expires, even the liability expires, too, and it has to be newly re-established. In case of short-time liability, customers have to fill in the starting time when they are accepting that liability; they then have to sign it. Ordinarily, it is not required to insert the expiration time.

Multimedia Session Establishment:

Once the liability distribution phase has terminated, the infrastructure proceeds with the classical SIP phase for the multimedia session establishment, achieved through the three-way handshake shown in FIG. 16. Note that this is the normal session setup phase provided by SIP as is already known in the art.

Liability Release:

Having described the liability establishment of the preferred embodiment of the invention, we will now discuss liability release. An operation of liability release is slightly subtler than the establishment one. Indeed, a party is enabled to release her liability, invalidating the related proof she previously provided, if and only if an appropriate party agrees her decision. Nevertheless, this section focuses on the fact that tearing down a liability invalidates the proof that a party is responsible for some actions within the session.

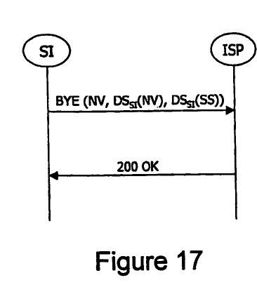

To complete our signalling infrastructure, we need to add some facilities for tearing down previously established liabilities. The easiest way to provide these mechanisms is to follow the same approach SIP does. When a party wishes to close a communication, she sends a BYE message request to the to other party, signalling her intention to abandon the multimedia session, as shown in FIG. 17. Such message will have to contain the nonce value of the session, the digital signature over the nonce value, and the digital signature over the signed statement referring to the liability to release. The receiving party, once processed the message, responds with a 2000K response, confirming the closure of the communication. At this point, the RTP session is torn down.

Behavioural Architecture

We turn now to the third part of our description of the embodiment, being that of a description of the method steps taken by each party to the invention, being the session initiator, the remote parties, the local ISP, and the remote ISPs.

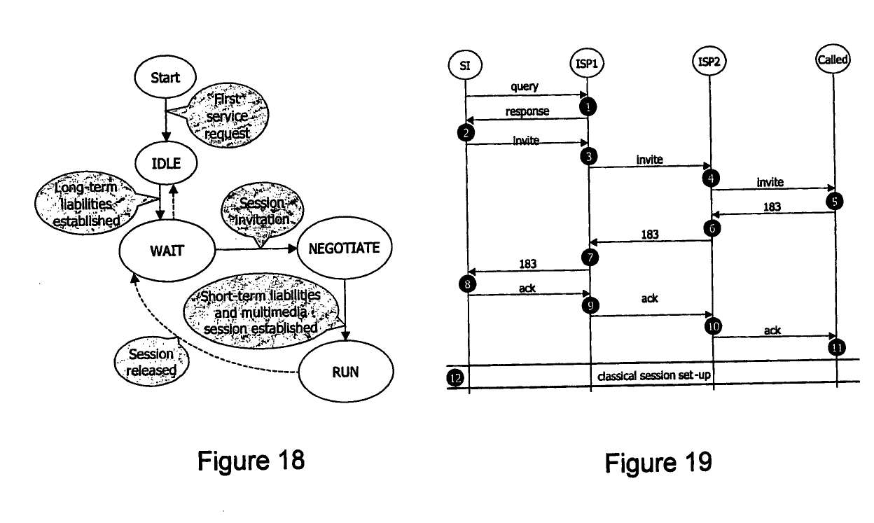

In FIG. 18, the overall behaviour of the system is summarised. Depending on the state of the liability establishment, the system can be in
IDLE: when a service request has been posted to the ISP.
WAIT: when the service request has been accepted and long-term liabilities are established
NEGOTIATE: when session invitations have been posted to all involved parties and portions of control are negotiated.
RUN: when short-term liabilities and the actual multimedia session are established.

In the proposed infrastructure, we do not provide any specific way of establishing long-term liabilities (except from the fact that the learning phase provides a suitable mechanism for also establishing long-term liabilities). We provide, on the opposite, all the required mechanisms for handling the system in WAIT, NEGOTIATE and RUN states.

In the following, the behaviour of the actors, during the new message exchanges, is described. The numbering of the state machines below refers to the states shown in FIG. 19.

At the session initiator, the SIP user agent behaviour needs to be extended in a number of points. Indeed, the session initiator has to start the process by requesting a charging policy from the local ISP. This performed at step 0 (not shown). Furthermore, as soon as the user agent receives an INVITE request, or a 183 response, or a ACK request, it has to make a decision on behalf of the customer, or with the help of the customer (in this case a certain interaction needs to be introduced). In turn, this decision implies that an appropriate part of the session description (that one containing the non-repudiable statements) has to be parsed, elaborated, and modified.

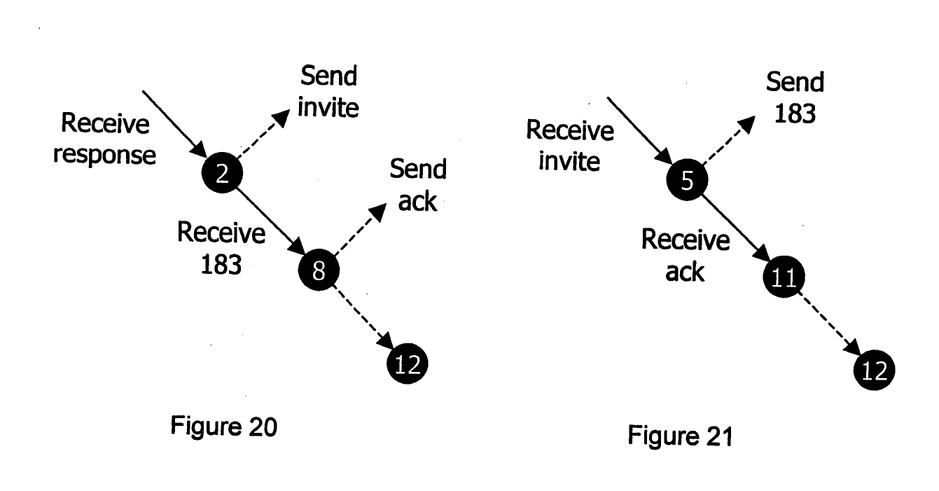

The states assumed by the session initiator are shown in FIG. 20. Here, when in state 2, upon receipt of the ISP's response, the session initiator will:
i) Evaluate the various charging policies and choose one of them; and
ii) If he decides to accept some portion of control among the ones available in the charging policy, he has to generate as many signed statements as the portions of control he accepts; the starting time of the liability will be the time in which it has been generated.

When in state 8, ie. upon receipt of all the 183 responses, the session initiator will:
i) Store all the signed statements;
ii) Include the statements in an ACK request; and
iii) Send hop-by-hop the ACK request to all the participants.

The next actions to be performed by the session initiator are then the classical call-set-up phase at state 12. The steps to be performed in this state are known in the art already.

With respect to a called participant, FIG. 21 illustrates the states which a called participant may assume. Here, as state 5 upon receipt of the INVITE request message from the session initiator, a participant will:
i) Decrypt with its private key the encrypted part of SIP message;
ii) Store the signed statements proving A's liability; and
iii) Check whether its user role (e.g. participant) is listed in some of the incomplete statements

If the third condition is true, then the called participant can decide to assume a task role (control function). In such a case, the called participant will then perform the following steps:
a) Complete the statement with her information;
b) Sign it; and
c) Send it back hop-by-hop to the session initiator, via a 183 (Session Progress) response message. The 183 message will also include the digital signature of the nonce value

If the third condition is not true, then the called participant may just send back a 183 response message including the digital signature of the nonce value.

The next actions to be performed by a called participant are in state 11. Here, upon receipt of an ACK request, each called participant will:
a) Store the signed statements; and
b) Stand-by for the classical session set-up phase to be performed at common state 12.

Then, at common state 12 the classical session set-up phase is performed, as already described.

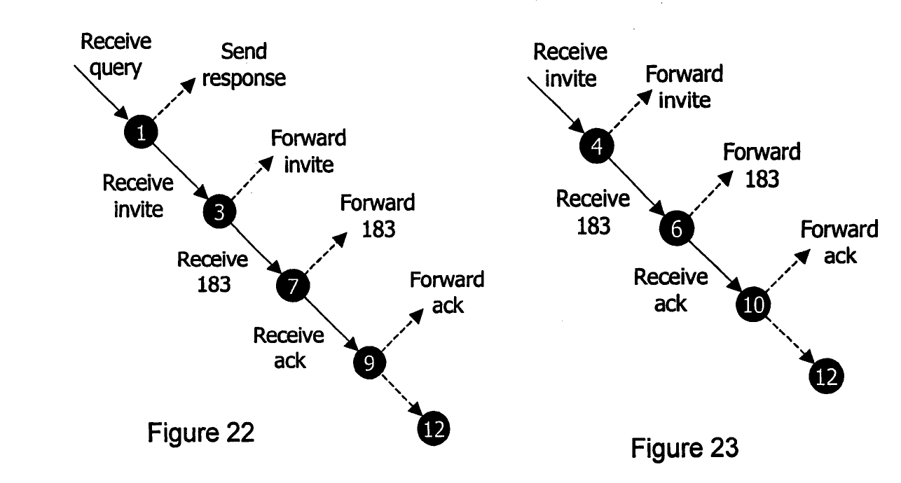

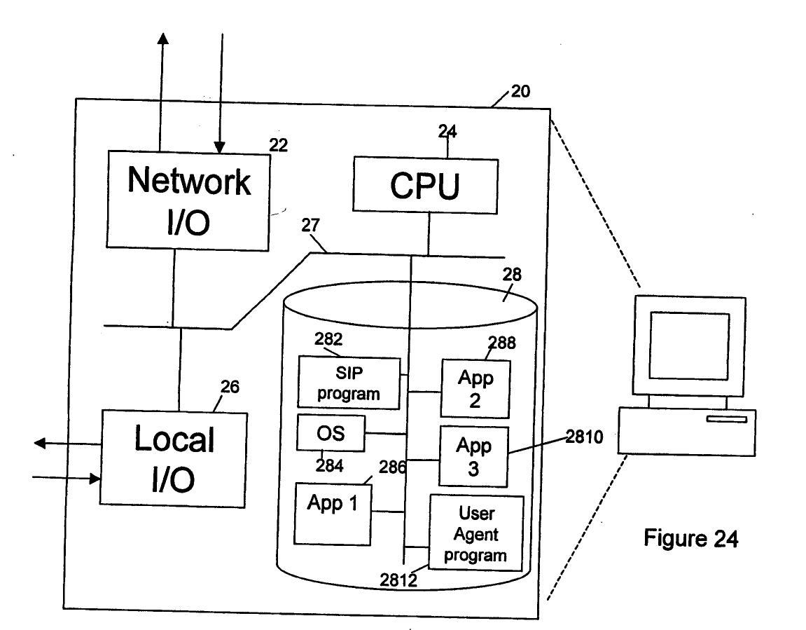

FIG. 22 shows the states which may be assumed by a user agent running on the local ISP's SIP server. What is presented below represents the algorithm according to which the user agent of the SIP server should be implemented within the embodiment of the invention.

At state 1, upon receipt of the session initiator's query, the local ISP will:
1. Retrieve the appropriate charging policies for the required service/session.
2. Reply to the session initiator with the set of charging policies (along with the corresponding signature) and a nonce value representing the session to be opened (along with the corresponding digital signature).

Next, at state 3 the local ISP receives an INVITE message from the session initiator, and performs the following steps:
1. The user agent decrypts with its private key the part of the SIP message that has been encrypted by the session initiator.
2. It checks whether the session initiator signed some of the statements. According to the correct behaviour, a party, who is the only one to act in its user role (e.g. the session initiator, that is unique within the session), must sign all the statements in which its role is mapped onto different task roles. If there exists more than one party behaving according to a certain user role, then there could be a negotiation in the assignment of the task roles. Practically, within a session there is only one session initiator, and more than one participant.
3. If the session initiator signed one or more statements, the user agent at the local ISP checks the sender's digital signature of the nonce value using the following steps:—
   a. It decrypts the message with the sender public key.
   b. It computes the hash value of the nonce value.
   c. It compares the newly computed hash value with that one it received from the sender. If they are equal, than the statement inside the INVITE request is validated. Otherwise, it should ask for retransmission (using an ACK request sent from the session initiator to the local SIP server).
4. If the session initiator signed one or more statements, it checks the sender's digital signature of the statements, using the following steps:—
   a. It decrypts the digital signature with the sender public key, obtaining the hash value of the statement.
   b. It computes to hash value of the statement (that has been sent along with the signature, inside the SIP payload).
   c. It compares the newly computed hash value with that one it received. If they are equal, than the sender is authenticated.
5. The user agent stores the non-repudiable proof that the session initiator assumed some of the task roles.
6. The user agent checks the remaining task roles that have not been still mapped.
7. Then, it forwards the SIP message towards the destination, encrypting the sensitive part of the SIP message with the remote ISPs SIP server key.

Following the above, the local ISP remains idle until state 7 whereupon it then receives the 183 ACK messages from the called participants on their way to the session initiator. The local ISP will see all the responses traveling towards the session initiator. Upon receipt of all of them, at state 7, the following steps are performed:—
1. Process the response messages' content and check for conflicts:
2. Check that all the portions of control have been chosen. If there are conflicts then the following steps are performed:
   a. In the case of not-accepted portions of control: the local ISP assigns not-accepted control to the session initiator, asking for as many signed statement as the portions of control are; or
   b. In the case of overlapping accepted control (more than one party over a portion): the local ISP leaves such control to only one of these parties and removes it from the others.

3. After step 2 of state 7 has been completed, the local ISP forwards the modified responses to the session initiator.

The local ISP then waits until state 9, when an ACK request is received from the session initiator. Upon receipt of an ACK request, at state 9 the local ISP will:
1. If it arbitrarily assigned some portion of control to the session initiator (when solving conflicts), before the ACK request is forwarded it will have to check that the session initiator has included the appropriate signed statements.
2. Otherwise, he forwards the message onwards towards the called participants without further processing.

The above concludes the particular steps performed by the local ISP. After the completion of state 9, the next actions performed by the local ISP are the classical session set-up phases described previously, within common state 12.

Turning now to the actions performed by the Remote ISPs, FIG. 23 illustrates the states assumed by a remote ISP during the performance of the embodiment of the invention. Firstly, in state 4 The remote SIP server's software user agent who receives the INVITE request performs the following:
1. Decrypt with its private key the encrypted part of SIP message; and
2. It stores the signed statements, and forwards the message towards the participant, encrypting the sensitive part of the SIP message using the public key of the participant.

Next, at state 6, upon receipt of a 183 response message, the remote ISP has simply to forward the message without any further processing. Following that, at state 10, upon receipt of an ACK request, each remote ISP stores all the included signed statements. Then, the remaining functions to be performed are the classical session set-up steps performed in common state 12. No further actions need be performed by any of the remote ISPs.

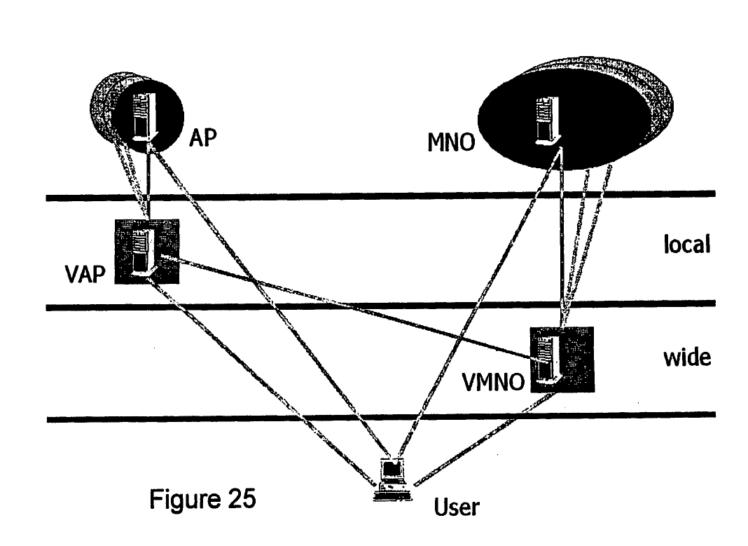

The above therefore concludes our description of the operation of the embodiment of the present invention. It will be understood by the intended reader that the above described functions are preferably implemented in software through an extended SIP user agent program loaded into a computer which is otherwise fulfilling the functions of each of the parties or “actors” in the invention. FIG. 25 illustrates a generalized block diagram of a computer which may take the role of any of the actors, when loaded with the appropriate SIP user agent software.

More particularly, FIG. 25 illustrates the operating environment of the present invention. More particularly, the embodiment of the present invention provides a user agent software program 2812, which is stored on a computer-readable storage medium such as the hard disk 28 provided in a user computer 20. By way of example, the user agent program 2812 may be part of a software application, part of a middleware, or a stand-alone program in its own right. Also stored on the hard disk 28 is an operating system program 284, a SIP program 282, and a number of other executable application programs App1 286, App2 288 and App3 2810, each of which possess functionality to access or send data over a network. The computer is further provided with a central processing unit 24 capable of executing computer program instructions, a central data bus 27 to provide internal communications between the components, a network input and output card 22 to allow interconnection of the computer to a network, and local input and output interface means 26 to allow connection of user input and output devices such as monitors, keyboard, mouse, printer, or the like.

It should of course be noted and would be understood by the intended reader that the above description is for illustrative purposes in respect of the present invention only, and in reality many more systems, subsystems and components would be required to provide a fully operational computer. Such additional elements are well known in the art, and should be taken as being implied herein.

In operation, the SIP program 282 provides the usual SIP functionality to enable classical call setup, whereas the user agent program 2812 acts according to the previously described method steps, dependent upon whether the computer 20 is acting as a session intiator, a called participant, a local ISP SIP server, or a remote ISP SIP server. Thus, where the computer 20 is a session initiator the user agent program 2812 controls the computer to perform the steps previously described for the session initiator, whereas where the computer 20 is acting as a local ISP server, then the steps prescribed therefor are performed by the computer under the control of the user agent program. The same is also true of the remote ISP and called participants, where the computer 20 is acting as one of these roles. Different versions of the user agent program may be available according to the role to be assumed, or the program may be able to control all the required steps for any role, it being configured to perform one particular role depending on the role of the computer 20 at any one time.

This extension of the method in “Ad hoc trust for sessions” is based on the fact that, depending on the kind of ‘session’ the method is applied to, we can define different sets of portions of control. The problem is always the same: establishing trust between possibly unknown participants of a session. The solving method is always the same: distributing portions of control to various parties, binding a liability to each one them, and distributing portions of control and liability to all participants. This ensures that all the involved parties have the means to blame potential parties abusing of their control. What changes in this extension is the notion of session and the control associated to it.

A second embodiment of the invention will now be described with respect to FIG. 25.

Within the first embodiment the invention was applied to multimedia sessions and therefore to control associated with them. In the second embodiment we now apply the same method to a different type of session. Here, a session is merely the instantiation of a communication service (it can be a web browsing session, an email download session, a voice call, a videoconference, or the like. As such it will be seen that this broader definition of session also encompasses the multimedia sessions of the first embodiment). As an example, within the second embodiment we consider the scenario of a user willing to buy a web browsing session through a WLAN (wireless local area network) “hot spot”, possibly using its existing identification maintained by his/her mobile network operator. Therefore, the participants of this session are the user, the hot-spot operator, and the mobile network operator. In order to maintain a certain generality of the scenario, we also include as potential participants the virtual WLAN access provider and a virtual mobile network operator.

In contrast with multimedia sessions, service sessions require a variety of functions in order to be controlled. For example, there are technical functions related to the actual transport of communications packets from one party to another, such as routing, handover, packet forwarding, QoS signalling, QoS determination, and so on (note how control of multimedia sessions is a low-granularity subset of control of service sessions) that allow control over the technical delivery of the communication service. And there are also what we will term here contractual (or business) technical functions, such as party identification, charging, metering, payment, and so on, that allow control over the business relationships engaged by providers and users. This set of portions of control is particularly interesting because a particular arrangement of contractual functions over different players determine a specific value chain and specific business models for the providers involved in the chain.

Therefore, by applying the priniciples of the present invention relating to ad-hoc trust establishment to such contractual functions of players in the value chain, not only do we establish ad hoc trust between possibly unknown players, but we also allow these players to re-arrange these functions among them dynamically and on a per session basis. Note how the set of participants can also change on a per session basis. Ultimately, by dynamically changing the arrangement of functions onto players, we allow players to support multiple business models at the same time. For example we have considered the following set of portions of control:
Service. Who delivers the communication service.
Identification. Who performs the identification service.
Offer dissemination. Who disseminates offers.
Offer selection. Who selects offers.
Metering and accounting. Who meters and accounts the communications service usage.
Charging. Who computes the charges.
Billing. Who prepares and send bills.
Payment. Who pays for the service session.

The list above is purely an example and it can be extended or detailed depending on the granularity of functions available on the operational support system (OSS) of a certain player. For example, it may be possible for a party to compute charges but not prepare the bill. If these exist as two separate functions, one for charging and one for billing, then the operation is not atomic and therefore we can define two separate portions of control and two separate portions of liability associated to such an operation.

FIG. 25 illustrates an example of the use of these broader notions of session and control as a second embodiment. Here, consider a user U, a WLAN access point owner AP, a reseller of access VAP, and a virtual mobile network operator VMNO (which is not necessarily a MVNO as defined by Oftel, the UK telecommunications regulatory body.). U is in Brazil and enters a local pub. The owner of the pub AP has set up a WLAN access point in the pub and agreed that VAP would resell access to the public. However, the access point has also been equipped with OSS features (i.e. contractual functions) owned by AP.

Assume that U would like to connect his/her laptop to AP's access point in order to browse the web; he/she decides then to buy an ad hoc web browsing session from VAP. However, U already holds an account with VMNO in the U.K. Therefore he would like him/herself to be charged on his account with VMNO. The three parties do not all know each (U has an existing trust relationship with VMNO, but that is all) and have no reason to trust each other. They need a method to initiate the session and be sure at the same time that if a party abuses the portion of its control, it can be subsequently blamed.

As discussed previously with respect to the first embodiment, the principles of the present invention allow various parties to a communications session to mutually exchange non-repudiable proofs of the portion of control owned, so that everybody is aware of everybody else's liabilities. They can then start the application session. In particular, if we consider a list of portions of control consisting of contractual functions (e.g. the list presented above), our method also allows the involved parties to dynamically re-assign these functions to different parties on a per session basis.

In the scenario to be described, we suggest that the user U behaves as the session initiator (this is reasonable because U actually starts the service session) in terms of signalling. However, this is not the only scenario; in fact, VAP could equivalently be the session initiator; this would imply few differences in the signalling phase.

The example scenario of the second embodiment comprises the following steps:
1. U communicates to VAP the will to start a session.
2. VAP replies with one or more charging policies. Each policy describes different ways of buying the service (e.g. buying a session from VAP and being authenticated by VAP; or buying a session from VAP and being authenticated by VMNO. And so on). Each charging policy also includes a list of available portions of control; let us assume that the list in question is the one suggested above.
3. U chooses one charging policy and chooses the portions of control he/she wants to own. Let us say that U chooses to own payment for the session.
4. U then invites VAP, HS and VMNO:
   a. Specifying the chosen charging policy.
   b. Specifying the chosen portions of control.
   c. Including the signed and non-repudiable statement discussed in respect of the first embodiment associated to the portions of control U accepted.
5. Upon receipt of the invitation, VAP, AP and VMNO:
   d. Store the signed statement proving U's liability.
   e. Choose one or more of the remaining portions of control. In practice, each parties will select some of the portions of control in the list.
   f. Generate a signed statement declaring accepted liability.
   g. Send the appropriate response to U.
6. Upon receipt of the replies, U will:
   h. Behaving as an arbiter, check that all the portions of control have been accepted. Solve possible conflicts.
   i. Store all the non-repudiable statements.
   j. Send an acknowledgement to VAP, AP and VMNO including the complete mapping between portions of control, accepting party, and non-repudiable statement.
7. Upon receipt of the acknowledgement, VAP, AP and VMNO will store the signed statements and be ready for initiating the delivery of the service, i.e. the instantiation of the session.

Thus it will be seen that the establishment of trust between parties using the principles of assuming portions of control relating to the session and signing a message to the other parties with non-repudiable data acknowledging the assumption of such control can be extended to cover the establishment of communications sessions more generally, and to cover portions of control relating to business technical functions as well as to technical aspects relating to the actual transport of data from one party to another.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A method for initiating a communications session involving two or more participants over a communications network, comprising the steps of:
exchanging messages containing non-repudiable data between said participants to establish at least one trust relationship therebetween relating to the session, said non-repudiable data indicating one or more session control functions to be assumed by individual participants during the session; and then
establishing the communications session.

2. A method according to claim 1, wherein the exchanging step comprises the following steps:
defining one or more control functions to be performed by at least one of the participants during the session;
communicating the defined control functions to the participants;
at each participant:
choosing which, if any, of the control functions the participant wishes to assume;
generating a non-repudiable message indicating the chosen function(s); and
transmitting the generated message to at least one of the other participants.

3. A method according to claim 2, wherein the non-repudiable message comprises: data indicative of the chosen function(s); and at least one digital signature of the participant related to said data.

4. A method according to claim 2, wherein the defining step comprises the step of communicating charging policy data including data indicative of the control functions to a first one of the participants who has requested it from a service provider; and the communicating step further comprises communicating the charging policy data from the first participant to the other participants.

5. A method according to claim 4, wherein at each other participant the generated non-repudiable message is transmitted back to the first participant.

6. A method according to claim 4, wherein the first participant assumes those control functions defined within the charging policy which no other participant has chosen to assume.

7. A method for establishing at least one trust relationship between two or more participants and relating to a communications session between said participants over a communications network, comprising the steps of:
requesting session control function data from a server, said data defining one or more control functions to be performed during the communications session;
choosing which, if any, of said control functions to assume;
distributing said control function data to at least one other participant over the communications network;
receiving a non-repudiable message from the at least one other participant containing non-repudiable data indicating which, if any, of the control functions the at least one other participants has assumed.

8. A method according to claim 7, wherein said distributing step further comprises distributing to the at least one other participant non-repudiable data indicating which, if any, of the control functions have been assumed.

9. A method for establishing at least one trust relationship between two or more participants and relating to a communications session between said participants over a communications network, comprising the steps of:
supplying, upon request from a participant, session control function data, said data defining one or more control functions to be performed during the communications session;
receiving non-repudiable data from said participants indicating which, if any, of the control functions each participant has assumed; and
storing said data.

10. A method according to claim 9, and further comprising the steps of: checking the received non-repudiable data for any conflicts in the assumed control functions between two or more participants; and
resolving any detected conflicts by assigning the disputed control function to only one of said participants who indicated that they would assume the function.

11. A method according to claim 9, and further comprising the steps of checking the received non-repudiable data to determine the control functions which have been assumed; and assigning any control functions which have not been assumed to a first participant, being the participant to which said network control function data was supplied.

12. A method for establishing at least one trust relationship between two or more participants and relating to a communications session between said participants over a communications network, comprising the steps of:
receiving control function data from a first participant over the communications network, said control function data defining one or more control functions to be performed during the communications session;
choosing which, if any, of said control functions to assume;
generating a non-repudiable message containing non-repudiable data indicating which, if any, of the control functions have been assumed; and
sending said message to the first participant.

13. A method according to claim 12, and further comprising receiving, together with said control function data, non-repudiable data indicating which, if any, of the control functions have been assumed by the first participant

14. A method according to claim 7, wherein said non-repudiable data comprises data indicative of a control function to be assumed, and a digital signature specific to the participant who has assumed the control function relating thereto.

15. A method according to claim 7, wherein said non-repudiable data further comprises a nonce value specific to the communications session, and a digital signature specific to the participant who has generated said non-repudiable data relating to the nonce value.

16. A computer program arranged such that when executed by a computer system it causes the computer system to operate according to claim 1.

17. A computer readable storage medium storing a computer program according to claim 16.

18. A system for establishing at least one trust relationship between two or more participants and relating to a communications session between said participants over a communications network, said system comprising processing means arranged to operate according to the method of claim 1.
